(19) United States
(12) Patent Application Publication
(10) Pub. No.: US 2015/0121054 A1
(43) Pub. Date: Apr. 30, 2015

(54) Platform Secure Boot

(71) Applicant: Advanced Micro Devices, Inc., Sunnyvale, CA (US)

(72) Inventor: Winthrop J. WU, Shrewsbury, MA (US)

(73) Assignee: Advanced Micro Devices, Inc., Sunnyvale, CA (US)

(21) Appl. No.: 14/068,102

(22) Filed: Oct. 31, 2013

(51) Int. Cl. G06F 21/57

(52) U.S. Cl. CPC G06F 21/575
USPC 713/2

(57) ABSTRACT

A system and method for securing a boot process on the electronic device using a hardware-based secure processor are provided. The hardware-based secure processor receives a boot instruction. In response to the received boot instruction, the hardware-based secure processor authenticates the boot code in hardware while stalling the processor. Once the boot code is authenticated, the processor is released from the stall and processes the boot code.

### BACKGROUND

1. Field

Embodiments disclosed herein are generally related to a boot process and specifically to secure boot processes with a hardware-based secure processor.

2. Background Art

Conventionally, to secure a boot process, electronic devices decrypt encrypted firmware and software. For instance, device drivers and operating system loaders that were digitally signed prior to boot up are decrypted at boot up. In this scenario, the electronic device decrypts the device drivers and operating system loaders, and prevents the loading of the device drivers and operating system loaders that were not signed with an acceptable digital signature or were not authenticated.

### BRIEF DESCRIPTION OF THE DRAWINGS/FIGURES

The accompanying drawings, which are incorporated herein and form part of the specification, illustrate the embodiments and, together with the description, further serve to explain the principles of the embodiments and to enable a person skilled in the pertinent art to make and use the embodiments. Various embodiments are described below with reference to the drawings, wherein like reference numerals are used to refer to like elements throughout.

FIG. 1 is a block diagram of a system that implements a secure boot process, according to an embodiment.

FIG. 2 is a block diagram of a secure boot process, according to an embodiment.

FIG. 3 is a flowchart of a secure boot process, according to an embodiment.

FIG. 4 is a block diagram of an exemplary electronic device where embodiments may be implemented.

The embodiments will be described with reference to the accompanying drawings. Generally, the drawing in which an element first appears is typically indicated by the leftmost digit(s) in the corresponding reference number.

### DETAILED DESCRIPTION OF EMBODIMENTS

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The term “embodiments” does not require that all embodiments include the discussed feature, advantage or mode of operation. Alternate embodiments may be devised without departing from the scope of the disclosure, and well-known elements of the disclosure may not be described in detail or may be omitted so as not to obscure the relevant details. In addition, the terminology used herein is for the purpose of describing particular embodiments only and is not intended to be limiting of the disclosure. For example, as used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

A system and method for securing a boot process on the electronic device using a hardware-based secure processor are provided. The hardware-based secure processor receives a boot instruction. In response to the received boot instruction, the hardware-based secure processor authenticates the boot code in hardware while stalling the processor. Once the boot code is authenticated, the processor is released from the stall and processes the boot code.

Further features and advantages of the embodiments, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

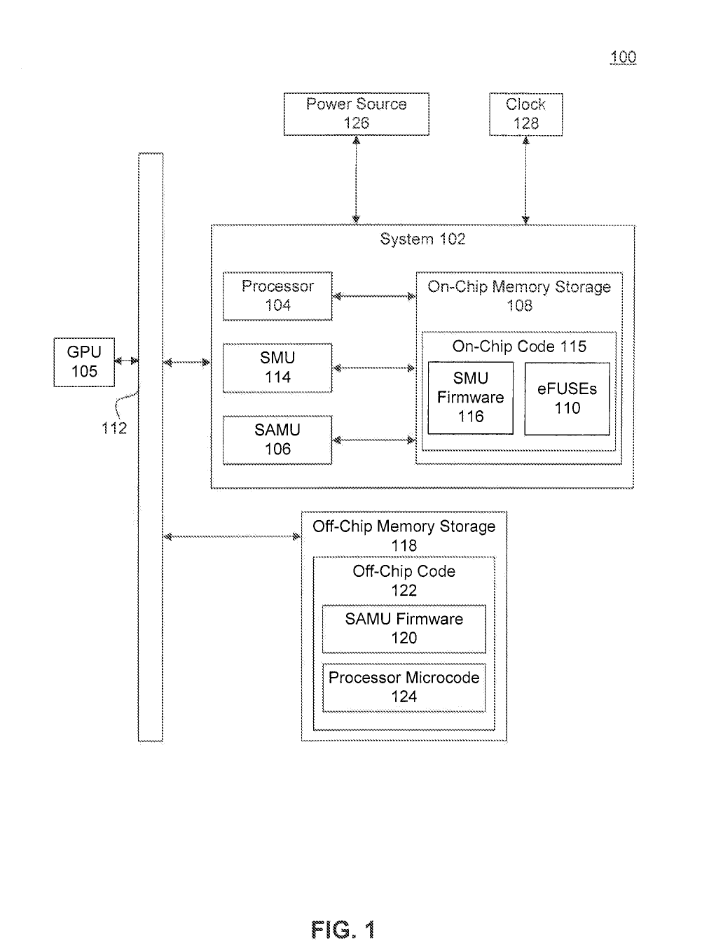

FIG. 1 is a block diagram 100 of a system that implements a secure boot process, according to an embodiment. To implement the secure boot process, an electronic device in block diagram 100 includes system 102. System 102 is an integrated circuit that includes hardware that detects code manipulation originating in the firmware, operating system, kernel, or any other component in the platform of the electronic device during boot up. If system 102 detects code manipulation, system 102 fails to load the manipulated code, issues an error message, or shuts down altogether. In an embodiment, system 102 may be an application specific integrated circuit (referred to as an ASIC) that may be customized for a particular use and may include microprocessors, on-chip memory blocks such as read-only memory (ROM), random access memory (RAM), flash memory, etc., as well as components described below. In an embodiment, system 102 also communicates with off-chip hardware and off-chip memory blocks.

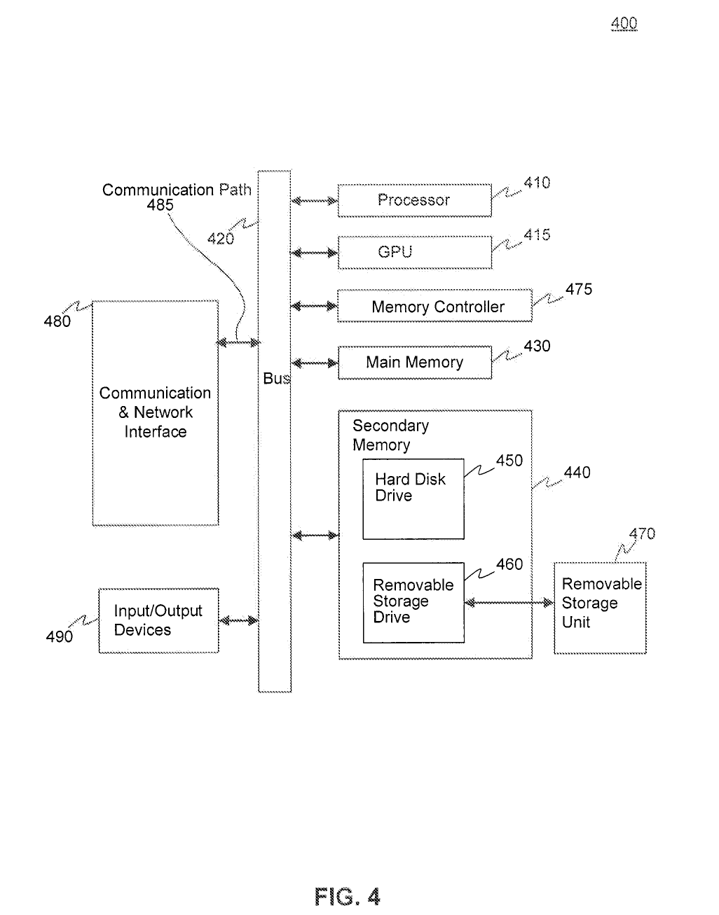

In an embodiment, system 102 includes a processor 104. Processor 104 initializes an operating system that executes on the electronic device, as well as instructions made by the operating system or the end user. In an embodiment, processor 104 may be a central processing unit (CPU) which carries out instructions of computer programs or applications as discussed in FIG. 4, or another processor. Example processor 104 is further discussed in detail in FIG. 4. In an embodiment, processor 104 is an unsecure processor and relies on computer program code authentication prior to the computer program code being executed by processor 104.

In another embodiment, system 102 is coupled to a graphics processing unit 105 (also referred to as GPU 105.) GPU 105 processes data in parallel, such as mathematically intensive graphics data. Example GPU 105 is further discussed in detail in FIG. 4.

In an embodiment, system 102 includes a secure asset management unit 106 (also referred to as SAMU 106). In an embodiment, SAMU 106 is a processor implemented in hardware that provides a hardware-based protected execution environment. For example, SAMU 106 verifies firmware and software prior to the firmware or software being executed on processor 104, GPU 105 or other components in the electronic device. In an embodiment, SAMU 106 authenticates boot code in hardware, in response to receiving a boot instruction from the electronic device.

In an embodiment, system 102 includes on-chip memory storage 108. Example on-chip memory storage 108 includes non-volatile memory that is discussed in detail in FIG. 4. In an embodiment, on-chip memory storage 108 may be a read-only memory that is set at manufacture time, and is not changed thereafter.

In an embodiment, on-chip memory storage 108 is located within system 102 and stores on-chip code 115. On-chip code 115 initializes components within system 102, such as processor 104, SAMU 106, system management unit 114 (also referred to as SMU 114) and a Peripheral Component Interconnect Express bus 112, to give a few examples, as discussed below.

On-chip code 115 may include electronic fuses or eFUSEs 110 and SMU firmware 116. eFUSEs 110 are memory components that are part of the non-volatile storage that are programmed once at manufacture time. Once programmed, eFUSEs 110 retain their values during and between power cycles. In an embodiment, eFUSEs 110 may be configured with chip or micro-chip settings, electronic device settings, cryptographic keys that establish the initial root-of-trust within the device and any data that must remain constant across power cycles.

In an embodiment, system 102 communicates with a Peripheral Component Interconnect Express bus 112 (referred to as PCIe 112.) In an embodiment, PCIe 112 is an input/output (I/O) bus that connects keyboard, monitor, mouse and other external I/O devices in the electronic device to system 102.

In an embodiment, system 102 also includes SMU 114. SMU 114 performs power management, monitors power consumption, performs temperature management, receives clock frequency from clock 128 and distributes the clock frequency to components in system 102. In an embodiment, SMU 114 executes SMU firmware 116. SMU firmware 116 includes instructions that load and otherwise control SMU 114 and accesses eFUSEs 110 that provide settings to SMU 114. In another embodiment, SMU firmware 116 initializes SMU 114.

In an embodiment, system 102 communicates with off-chip memory storage 118. Off-chip memory storage 118 is a volatile or non-volatile storage located in an electronic device outside of system 102. Example non-volatile storage is discussed in FIG. 4.

In an embodiment, off-chip memory storage 118 stores off-chip code 122. Off-chip code 122 may be uploaded from off-chip memory storage 118 to system 102 for execution using processor 104 or SAMU 106. Because off-chip code 122 is uploaded onto system 102, off-chip code 122 may be compromised before or after it is stored in off-chip memory storage 118. Conventionally, off-chip code may be signed using a digital signature. However, a digital signature does not guarantee the authenticity of the off-chip code since both the off-chip code and signature could be compromised before execution. As a result, a conventional electronic device may be booted up using compromised off-chip code.

In an embodiment, prior to processor 104 executing off-chip code 122, SAMU 106 authenticates off-chip code 122 based upon the root-of-trust stored in eFUSEs 110. In an embodiment, off-chip code 122 may include the basic input/output system (BIOS). The BIOS initializes hardware components within system 102 and loads an operating system from memory storage (on-chip memory storage 108, off-chip memory storage 118, or another memory storage) to execute on the electronic device.

In an embodiment, off-chip code 122 includes SAMU firmware 120. SAMU firmware 120 includes instructions that control SAMU 106. SAMU firmware 120 may include instructions that process settings included in eFUSEs 110 that initialize SAMU 106.

In an embodiment, off-chip code 122 includes processor microcode 124. Processor microcode 124 may be executed using processor 104. In an embodiment, prior to processor 104 executing processor microcode 124, SAMU 106 authenticates processor microcode 124.

In an embodiment, system 102 receives power from a power source 126. In an embodiment, power source 126 may be a battery included in an electronic device that hosts system 102. In another embodiment, power source 126 may be an external power source, such as an AC power socket, electrical outlet, a DC power source, etc. Once the electronic device receives instructions to activate, power source 126 provides power to the electronic device and system 102 within the electronic device. A person skilled in the art will appreciate that the electronic device may store enough power to receive instructions to activate power source 126. In one embodiment, when power source 126 is activated, it distributes SMU firmware 116 and eFUSEs 110 to SMU 114.

In an embodiment, system 102 is coupled to a clock 128. Clock 128 regulates rate at which instructions are executed by processor 104 or GPU 105, and sets clock frequency that determines the speed at which instructions execute in system 102 and the rest of the electronic device.

When an electronic device receives reset instructions, from, for example, a user, a network, or software executing on the electronic device, the electronic device powers on and reboots. Conventionally, during the boot processes, the electronic device authenticates firmware and software, such as operating system and other processes using a digital signature attached to the software. When software is signed with a digital signature, there is a reliance that software operates properly and has not been compromised prior to signing. For example, during the boot process, the electronic device does not check whether firmware or software have been compromised prior to encryption, even though the digital signature was authenticated. Further, there is no guarantee that the BIOS, which may also be stored in the off-chip memory storage, have not been compromised and the electronic device is being booted up with compromised BIOS.

To authenticate off-chip code 122, SAMU 106 processes off-chip code 122 and determines whether the code itself has been compromised based upon the root-of-trust in eFUSEs 110, in an embodiment. Unlike simply authenticating the digital signature of off-chip code 122, SAMU 106 validates the off-chip code 122 prior to execution using processor 104 based upon the root-of-trust embedded in eFUSEs 110. If the validation fails, SAMU 106 terminates the boot process and eliminates a possibility that the malicious code will be executed by processor 104. To authenticate off-chip code 122 during the boot processes, system 102 stalls processor 104 until SAMU 106 authenticates off-chip code 122. For instance, during the authentication, SAMU 106 executes and authenticates SAMU firmware 120 and processor microcode 124, which includes BIOS. After SAMU 106 completes authentication, SAMU 106 signals processor 104 to come out of the stall and proceed with the boot process. If the authentication fails, SAMU 106 terminates the boot process.

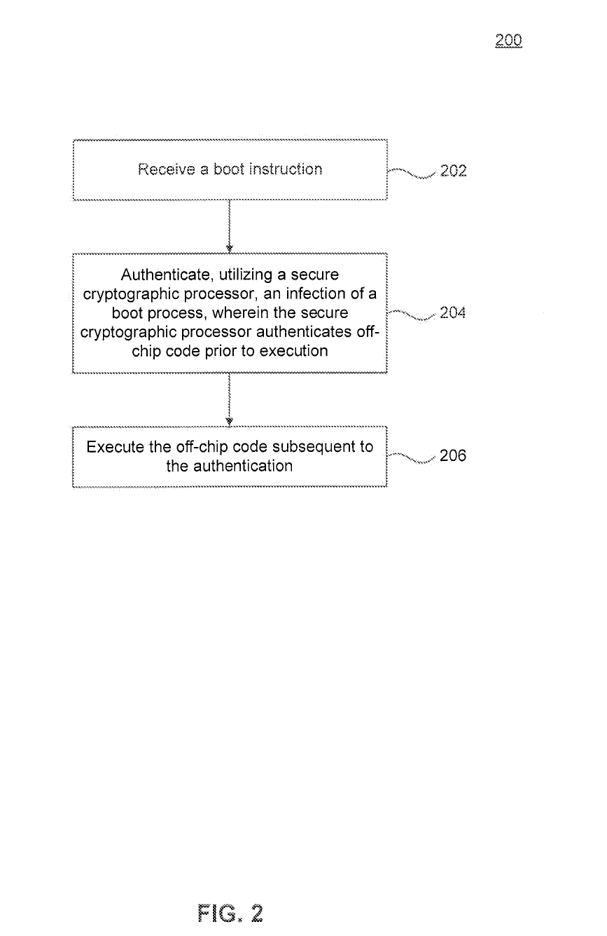

FIG. 2 is a flowchart 200 of a secure boot process, according to an embodiment.

At operation 202, a boot instruction is received. For instance, the electronic device receives a reset instruction from a user or from an application executing in the electronic device.

At operation 204, a hardware based authentication of the boot code is implemented. For instance, SAMU 106 is initialized and performs hardware-based authentication of the BIOS, off-chip code 122 and processor microcode 124 prior to them being executed by processor 104. If the authentication fails, SAMU 106 identifies an infection of the boot process, (such as malicious code that has been inserted into the boot process) and terminates the boot process. In an embodiment, SAMU 106 also stalls processor 104 until SAMU 106 authenticates the BIOS, off-chip code 122 and processor microcode 124.

At operation 206, the boot code is executed subsequent to the authentication. For instance, once authentication completes, SAMU 106 sends a signal to processor 104 that terminates the stall of processor 104. In another embodiment, SAMU 106 writes to a register whose value processor 104 periodically checks while in a stall, and when the register is set, terminates the stall. Once processor 104 is brought out of the stall, processor 104 processes the authenticated BIOS, off-chip code 122 and processor microcode 124.

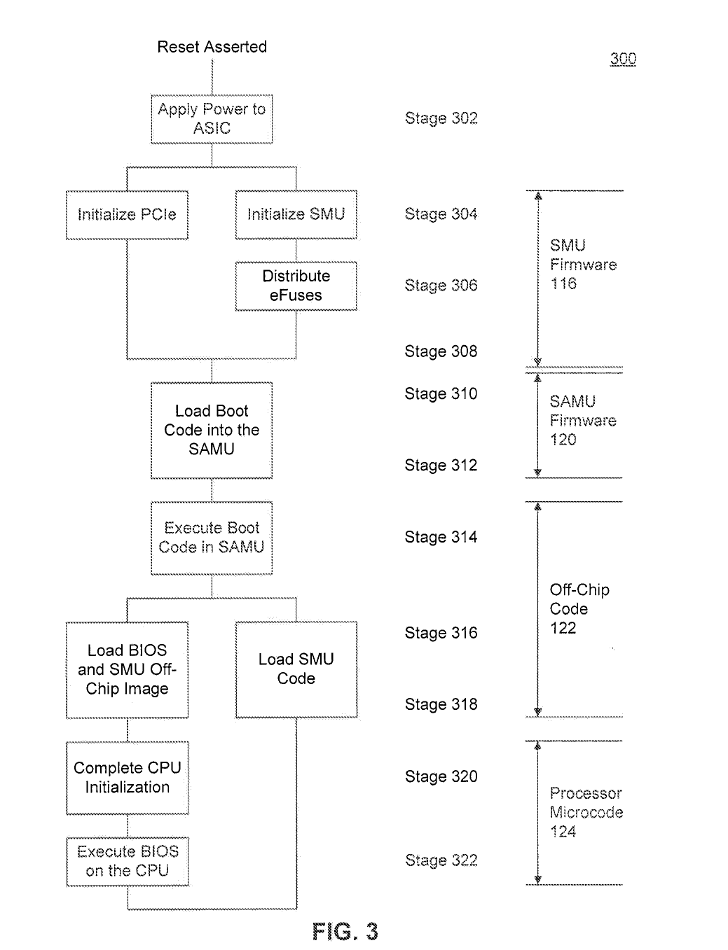

FIG. 3 is a block diagram 300 of a secure boot process, according to an embodiment. In block diagram 300, the electronic device performs a secure boot using components in system 102. The secure boot detects and prevents infection of the boot process by malicious software or other malicious activity, and establishes a secure computation environment for system 102 and the electronic device.

In an embodiment, block diagram 300 includes eleven stages (stages 1-11). Each of the stages 1-11 utilizes components discussed in system 102, as demonstrated below. Prior to stage 1, a reset is asserted on the electronic device. In an embodiment, the reset generates a boot instruction that initiates the boot process.

At stage 302, a system is powered up. For instance, in response to a reset request an electronic device generates a boot instruction that causes power source 126 to activate system 102. As part of the power up, clock 128 is initialized.

As stage 304, SMU and PCIe are initialized. For instance, PCIe 112 is initialized and powered up so that PCIe 112 can propagate instructions to other components in the electronic device, such as GPU 105. In parallel, SMU 114 is also initialized using on-chip code 115 that includes SMU firmware 116, and retrieves eFUSEs 110. As part of the initialization, SMU 114 also initializes GPU 105.

At stage 306, eFUSEs are distributed. For instance, SMU 114 distributes eFUSEs 110 to SAMU 106 and PCIe 112.

At stage 308, initialization of PCIe and SAMU completes. For instance, PCIe 112 and SAMU 106 receive and complete initialization using values in eFUSEs 110.

In an embodiment, stages 302-308 are completed using on-chip code 115 that is stored in on-chip memory storage 108. In an embodiment, on-chip code 115 is stored in ROM at manufacture time, and has a low chance of being compromised.

At stage 310, boot code is loaded into SAMU and authenticated. Once SAMU 106 receives eFUSEs 110, SAMU 106 retrieves the boot code from off-chip memory storage 118. Example boot code may include SAMU firmware 120 and off-chip code 122. In an embodiment, SAMU 106 authenticates off-chip code 122 based upon the root-of-trust embedded in eFUSEs 110. Because SAMU 106 is implemented in hardware, at stage 310, hardware authenticates off-chip code 122. In an embodiment, until stage 310 completes, off-chip code 122 that includes firmware and other software does not execute within system 102.

At stage 312, a processor stalls. As SAMU 106 authenticates off-chip code 122, processor 104 begins to execute processor microcode 124. However, as processor 104 begins to execute processor microcode 124, SAMU 106 stalls processor 104 by, for example, causing processor 104 to enter into a stall loop. SAMU 106 stalls processor 104 until SAMU 106 completes authentication of stage 310. In an embodiment, stage 312 occurs in parallel with stage 310.

In an embodiment, stages 310-312 are completed using SAMU firmware 120.

At stage 314, SAMU executes the authenticated code. For instance, if the authentication is successful, SAMU 106 executes off-chip code 122. The executed off-chip code 122 initializes system 102. As part of the authentication, SAMU 106 authenticates BIOS that processor 104 uses to initialize the operating system, kernel, etc., on the electronic device.

At stage 316, the off-chip code is downloaded to processor and SMU. For example, off-chip code 122 that includes BIOS and SMU image are downloaded from off-chip memory storage 118. For instance, off-chip code 122 that includes an image of SMU's settings is downloaded to SMU 114, and BIOS are downloaded to SMU 114 and processor 104.

At stage 318, the BIOS and SMU off-chip code are prepared for execution. For instance, SAMU 106 decrypts, decompresses and authenticates the off-chip code 122 that includes the SMU image and executable code, and BIOS.

In an embodiment, in stages 320-322 system 102 executes off-chip code 122.

At stage 320, a processor resumes execution. For instance, SAMU 106 issues a signal to processor 104 that indicates to processor 104 to exit from the stall loop. Once processor 104 exits from the stall loop, processor 104 continues to execute processor microcode 124.

At stage 322, a processor processes BIOS. For instance, processor 104 processes BIOS downloaded in stage 316 and proceeds with the electronic device initialization process.

In an embodiment, in stages 320-322 system 102 executes processor microcode 124.

Various aspects of the disclosure can be implemented by software, firmware, hardware, or a combination thereof. FIG. 4 illustrates an example computer system 400 in which the contemplated embodiments of FIGS. 1-3, or portions thereof, can be implemented as computer-readable code. For example, the methods illustrated by flowcharts described herein can be implemented in system 400. Various embodiments are described in terms of this example computer system 400. After reading this description, it will become apparent to a person skilled in the relevant art how to implement the embodiments using other computer systems and/or computer architectures.

Computer system 400 includes one or more processors, such as processor 410. Processor 410 can be a special purpose or a general purpose processor. Processor 410 is connected to a communication infrastructure 420 (for example, a bus or network). Processor 410 may be a CPU processor which carries out instructions of computer programs or applications. For example, a CPU carries out instructions by performing arithmetical, logical and input/output operations of the computer programs or applications. In an embodiment, the CPU performs sequential processing, that may include control instructions that include decision making code of a computer program or an application, and delegates processing to other processors in the electronic device, such as a graphics processing unit (“GPU”).

In an embodiment, computer system 400 also includes a GPU 415. GPU 415 is a processor that is a specialized electronic circuit designed to rapidly process mathematically intensive applications on electronic devices. The GPU has a highly parallel structure that is efficient for parallel processing of large blocks of data, such as mathematically intensive data of the computer graphics applications, images and videos.

Computer system 400 also includes a main memory 430, and may also include a secondary memory 440. Main memory may be a volatile memory or non-volatile memory, and divided into channels as discussed above. Secondary memory 440 may include, for example, non-volatile memory such as a hard disk drive 450, a removable storage drive 460, and/or a memory stick. Removable storage drive 460 may comprise a floppy disk drive, a magnetic tape drive, an optical disk drive, a flash memory, or the like. The removable storage drive 460 reads from and/or writes to a removable storage unit 470 in a well-known manner. Removable storage unit 470 may comprise a floppy disk, magnetic tape, optical disk, etc. which is read by and written to by removable storage drive 460. As will be appreciated by persons skilled in the relevant art(s), removable storage unit 470 includes a computer usable storage medium having stored therein computer software and/or data.

In alternative implementations, secondary memory 440 may include other similar means for allowing computer programs or other instructions to be loaded into computer system 400. Such means may include, for example, a removable storage unit 470 and an interface (not shown). Examples of such means may include a program cartridge and cartridge interface (such as that found in video game devices), a removable memory chip (such as an EPROM, or PROM) and associated socket, and other removable storage units 470 and interfaces which allow software and data to be transferred from the removable storage unit 470 to computer system 400.

Computer system 400 may also include a memory controller 475. Memory controller 475 controls data access to main memory 430 and secondary memory 440.

Computer system 400 may also include a communications and network interface 480. Communication and network interface 480 allows software and data to be transferred between computer system 400 and external devices. Communication and network interface 480 may include a modem, a communications port, a PCMCIA slot and card, or the like. Software and data transferred via communication and network interface 480 are in the form of signals which may be electronic, electromagnetic, optical, or other signals capable of being received by communication and network interface 480. These signals are provided to communication and network interface 480 via a communication path 485. Communication path 485 carries signals and may be implemented using wire or cable, fiber optics, a phone line, a cellular phone link, an RF link or other communications channels.

The communication and network interface 480 allows the computer system 400 to communicate over communication networks or mediums such as LANs, WANs the Internet, etc. The communication and network interface 480 may interface with remote sites or networks via wired or wireless connections.

In this document, the terms “computer program medium” and “computer usable medium” and “computer readable medium,” and “non-transitory computer readable medium” are used to generally refer to media such as removable storage unit 470, removable storage drive 460, and a hard disk installed in hard disk drive 450. Signals carried over communication path 485 can also embody the logic described herein. Computer program medium and computer usable medium can also refer to memories, such as main memory 430 and secondary memory 440, which can be memory semiconductors (e.g. DRAMs, etc.). These computer program products are means for providing software to computer system 400.

Computer programs (also called computer control logic) are stored in main memory 430 and/or secondary memory 440. Computer programs may also be received via communication and network interface 480. Such computer programs, when executed, enable computer system 400 to implement embodiments as discussed herein. In particular, the computer programs, when executed, enable processor 410 to implement the disclosed processes, such as the steps in the methods illustrated by flowcharts discussed above. Accordingly, such computer programs represent controllers of the computer system 400. Where the embodiments are implemented using software, the software may be stored in a computer program product and loaded into computer system 400 using removable storage drive 460, interfaces, hard drive 450 or communication and network interface 480, for example.

The computer system 400 may also include input/output/display devices 490, such as keyboards, monitors, pointing devices, etc.

Embodiments can be accomplished, for example, through the use of general-programming languages (such as C or C++), hardware-description languages (HDL) including Verilog HDL, VHDL, Altera HDL (AHDL) and so on, or other available programming and/or schematic-capture tools (such as circuit-capture tools). The program code can be disposed in any known computer-readable medium including semiconductor, magnetic disk, or optical disk (such as CD-ROM, DVD-ROM). As such, the code can be transmitted over communication networks including the Internet and internets. It is understood that the functions accomplished and/or structure provided by the systems and techniques described above can be represented in a core (such as a CPU core and/or a GPU core) that is embodied in program code and may be transformed to hardware as part of the production of integrated circuits.

The embodiments are also directed to computer program products comprising software stored on any computer-usable medium. Such software, when executed in one or more data processing devices, causes a data processing device(s) to operate as described herein or, as noted above, allows for the synthesis and/or manufacture of electronic devices (e.g., ASICs, or processors) to perform embodiments described herein. Embodiments employ any computer-usable or -readable medium, and any computer-usable or -readable storage medium known now or in the future. Examples of computer-usable or computer-readable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nano-technological storage devices, etc.), and communication mediums (e.g., wired and wireless communications networks, local area networks, wide area networks, intranets, etc.).

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the embodiments should not be limited by any of the above-described exemplary embodiments, but should be defined only in accordance with the following claims and their equivalents.

What is claimed is:

1. A system comprising:
a hardware-based secure processor configured to:
receive a boot instruction;
in response to the received boot instruction, authenticate a boot code in hardware while stalling an unsecure processor, wherein the unsecure processor executes the boot code; and
release the unsecure processor from the stall once the authentication completes.

2. The system of claim 1, wherein the boot instruction is a reset instruction.

3. The system of claim 1, wherein the hardware-based secure processor is a cryptographic secure processor.

4. The system of claim 1, wherein the hardware-based secure processor is a secure asset management unit.

5. The system of claim 1, wherein the hardware-based secure processor is further configured to:
authenticate a basic input/output system (BIOS) prior to the unsecure processor executing instructions included in the BIOS.

6. The system of claim 1, further comprising:
an on-chip memory configured to initialize the unsecure processor in response to the boot instruction, wherein the on-chip memory is located within an integrated circuit that includes the unsecure processor.

7. The system of claim 1, further comprising:
an off-chip memory configured to store the boot code, wherein the off-chip memory is located outside of an integrated circuit that includes the unsecure processor.

8. The system of claim 1, further comprising:
an off-chip memory configured to store a secure processor firmware, wherein the secure processor firmware initializes the hardware based secure processor and causes the hardware based secure processor to load and authenticate the boot code and wherein the off-chip memory is located outside of an integrated circuit that includes the unsecure processor.

9. The system of claim 1, wherein the hardware-based secure processor is further configured to decrypt or decompress off-chip code executable on the unsecure processor, and wherein the unsecure processor executes the off-chip code subsequent to the decryption or decompression of the off-chip code.

10. The system of claim 9, wherein the hardware-based secure processor authenticates the off-chip code and not the encryption of the off-chip code based on a root-of-trust embedded in an electronic fuse (eFUSE).

11. A method comprising:
receiving a boot instruction; and
in response to the received boot instruction, authenticating a boot code using a hardware-based secure processor while stalling an unsecure processor that executes the boot code; and
releasing the unsecure processor from the stall once the authentication completes, wherein the released unsecure processor executes the boot code.

12. The method of claim 11, wherein the boot instruction is a reset instruction.

13. The method of claim 11, wherein the hardware-based secure processor is a cryptographic secure processor.

14. The method of claim 11, wherein the hardware-based secure processor is a secure asset management unit.

15. The method of claim 11, further comprising:
authenticating a basic input/output system (BIOS) prior to the processor executing instructions included in the BIOS.

16. The method of claim 11, further comprising:
initializing the unsecure processor in response to the boot instruction using an on-chip memory code, wherein the on-chip memory code is stored within an integrated circuit that includes the unsecure processor.

17. The method of claim 11, further comprising:
storing the boot code in an off-chip memory, wherein the off-chip memory is located outside of an integrated circuit that includes the unsecure processor.

18. The method of claim 11, further comprising:
initializing, using the secure processor firmware, the hardware-based secure processor; and
causing the hardware-based secure processor to load and authenticate the boot code.

19. The method of claim 11, further comprising:
decrypting or decompressing off-chip code executable on the unsecure processor, using the hardware-based secure processor; and
executing, using the unsecure processor the off-chip code subsequent to the decryption or decompression of the off-chip code, wherein the off-chip code is stored in an off-chip memory located outside of an integrated circuit that includes the unsecure processor.

20. The method of claim 19, wherein the hardware-based secure processor authenticates the off-chip code and not the encryption of the off-chip code based on a root-of-trust embedded in an electronic fuse (eFUSE).
